(19) United States
(12) Patent Application Publication
(10) Pub. No.: US 2026/0141482 A1
(43) Pub. Date: May 21, 2026

(54) IMAGE PROCESSING SYSTEM, IMAGE PROCESSING METHOD AND PROGRAM

(71) Applicant: Sony Interactive Entertainment Inc., Tokyo (JP)

(72) Inventors: Hirotaka Asayama, Kanagawa (JP); Ryota Ito, Kanagawa (JP); Shoichi Ikenoue, Chiba (JP)

(21) Appl. No.: 19/449,219

(22) Filed: Jan. 14, 2026

Related U.S. Application Data
(63) Continuation of application No. PCT/JP2024/024354, filed on Jul. 5, 2024.

(30) Foreign Application Priority Data
Jul. 14, 2023 (JP) 2023-115931

(51) Int. Cl. G06T 3/4053; A63F 13/52; G06T 3/4046

(52) U.S. Cl. CPC G06T 3/4053; A63F 13/52; G06T 3/4046

(57) ABSTRACT

An image processing system includes at least one processor configured to: acquire each of first to Nth (N is greater than or equal to 3) input frames having an input pixel count equal to or greater than a predetermined initial pixel count, corresponding to first to Nth processing target frames having the predetermined initial pixel count; acquire each of first to ith (i is greater than or equal to 1 and less than or equal to N−2) estimated frames having an estimated pixel count greater than the initial pixel count, based on the first to ith input frames and a first machine learning model; and acquire each of i+1th to jth (j is a natural number greater than or equal to i+2 and less than or equal to N) estimated frames based on the i+1th to jth input frames and a second machine learning model

### CROSS-REFERENCE TO RELATED APPLICATIONS

This application is a bypass-continuation application of and claims the benefit of priority to PCT Application No. PCT/JP2024/024354, filed on Jul. 5, 2024, which claims priority to Japanese Application No. 2023-115931, filed on Jul. 14, 2023, the contents of which are hereby incorporated by reference.

### TECHNICAL FIELD

The present invention relates to image processing systems, image processing methods, and programs.

### BACKGROUND TECHNOLOGY

Conventionally, a technology known as super-resolution, which uses a machine learning model to estimate a high-quality image based on a low-quality image, is known. See, for example Chao Dong, Chen Change Loy, Kaiming He, Xiaoou Tang. Learning a Deep Convolutional Network for Image Super-Resolution, in Proceedings of European Conference on Computer Vision (ECCV), 2014.

### SUMMARY

The inventors of the present application are considering a system having the following recursive configuration (hereinafter, sometimes referred to as “Reference Technology”) to achieve super-resolution of moving images such as game screens. In other words, this system inputs a current frame, i.e., an nth frame, and information on past frames, i.e., accumulated feature information indicating features of first to n−1th frames, into a machine learning model to improve the image quality of the nth frame (see FIG. 2).

In this way, by using accumulated feature information that accumulates information on past frames in addition to the current frame for estimation, it can be expected to improve the estimation accuracy of the machine learning model.

However, if estimations for early frames and later frames are performed using a single machine learning model, as in the Reference Technology mentioned above, the accuracy of estimations for early frames will be lower than that for later frames, since less information about past frames has been accumulated in the early stages. In particular, for the first frame, the decrease in estimation accuracy is more pronounced since no information on past frames has been stored.

To solve the problems above, an object of the disclosed technology is to provide an image processing system, an image processing method, and a program, each of which enable estimation of high-quality frames with high accuracy even for early frames.

An image processing system according to the present disclosure includes at least one processor, wherein the at least one processor is configured to: acquire each of first to Nth (N is a natural number greater than or equal to 3) input frames having an input pixel count equal to or greater than a predetermined initial pixel count, corresponding to first to Nth processing target frames having the predetermined initial pixel count; acquire each of first to ith (i is a natural number greater than or equal to 1 and less than or equal to N−2) estimated frames having an estimated pixel count greater than the initial pixel count, based on the first to ith input frames and a first machine learning model; and acquire each of i+1th to jth (j is a natural number greater than or equal to i+2 and less than or equal to N) estimated frames, based on the i+1th to jth input frames and a second machine learning model, wherein the first machine learning model outputs an nth (n is a natural number greater than or equal to 1 and less than or equal to i) estimated frame and an nth piece of accumulated feature information indicating features of the first to nth input frames based on the nth input frame, wherein the second machine learning model outputs the i+1th estimated frame and the i+1th piece of accumulated feature information indicating features of the first to i+1th input frames based on the i+1th input frame and the ith piece of accumulated feature information output from the first machine learning model and indicating features of the first to ith input frames, and outputs the mth estimated frame (m is a natural number equal to or greater than i+2 and less than or equal to j) and the mth piece of accumulated feature information indicating features of the first to mth input frames based on the mth input frame and the m−1th piece of accumulated feature information indicating features of the first to m−1th input frames, wherein the first machine learning model is further trained using first to ith pieces of training data which respectively includes first to ith training input frames having the input pixel count and first to ith training estimated frames having the estimated pixel count, wherein the second machine learning model is further trained using the i+1th to jth pieces of training data which respectively includes the i+1th to jth training input frames having the input pixel count and the i+1th to jth training estimated frames having the estimated pixel count, and trained based on an ith piece of training accumulated feature information output from the first machine learning model and indicating features of the first to ith training input frames.

### BRIEF DESCRIPTION OF THE DRAWINGS

FIG. 1 is a diagram illustrating one example of a hardware configuration of an image processing system.

FIG. 2 is a diagram illustrating an overview of the Reference Technology.

FIG. 3 is a diagram illustrating schematically processing in the Reference Technology.

FIG. 4A is a diagram illustrating an overview of the image processing system.

FIG. 4B is a diagram illustrating an overview of the image processing system.

FIG. 4C is a diagram illustrating an overview of the image processing system.

FIG. 5 is a functional block diagram illustrating one example of functions implemented in the image processing system.

FIG. 6 is a diagram illustrating processing in a rendering unit.

FIG. 7 is a diagram illustrating processing in an input frame acquisition unit.

FIG. 8A is a flow diagram illustrating one example of a processing flow executed in the image processing system.

FIG. 8B is a flow diagram illustrating one example of the processing flow executed in the image processing system.

FIG. 8C is a flow diagram illustrating one example of the processing flow executed in the image processing system.

### DETAILED DESCRIPTION

Hereinafter, one example of an embodiment of an image processing system according to the present disclosure will be described with reference to the drawings.

### 1. Hardware Configuration of Image Processing System

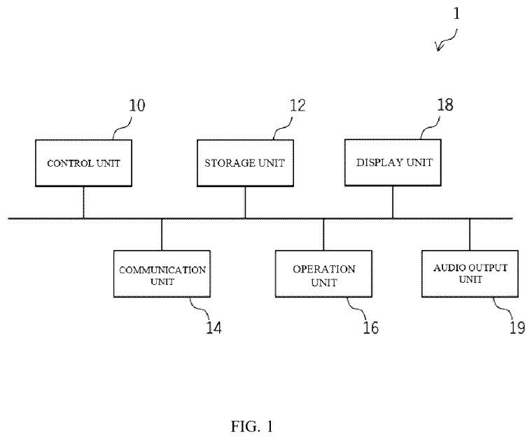

FIG. 1 is a diagram illustrating one example of a hardware configuration of an image processing system 1. The image processing system 1 is, for example, a computer such as a game console. As shown in FIG. 1, the image processing system 1 includes a control unit 10, a storage unit 12, a communication unit 14, an operation unit 16, a display unit 18, and an audio output unit 19.

The control unit 10 includes a program control device such as a CPU that operates according to a program installed in the image processing system 1, for example. The control unit 10 also includes a graphics processing unit (GPU) that draws images in a frame buffer based on graphics commands and data supplied from the CPU.

The storage unit 12 includes, for example, a main storage device such as a ROM or a RAM, and an auxiliary storage device such as an HDD or an SSD. The storage unit 12 stores, for example, programs executed by the control unit 10. The storage unit 12 stores, for example, a game program (game software) in addition to programs for implementing various functions of the image processing system 1, which will be described later. The storage unit 12 also has a frame buffer area reserved for images drawn by the GPU.

The communication unit 14 is a communication interface such as an Ethernet (registered trademark) module or a wireless LAN module.

The operation unit 16 is a user interface such as a keyboard, mouse, or game console controller, and receives operation inputs from a user and outputs signals indicating the contents of the inputs to the control unit 10.

The display unit 18 is a display device such as a liquid crystal display or an organic EL display, and displays various images according to instructions from the control unit 10.

The audio output unit 19 is, for example, a speaker, and outputs audio represented by audio data generated by the image processing system 1.

In addition to the devices mentioned above, the image processing system 1 may also include an optical disc drive that reads optical discs such as DVD-ROMs and Blu-ray (registered trademark) discs, a universal serial bus (USB) port, etc.

### 2. Overview of Reference Technology

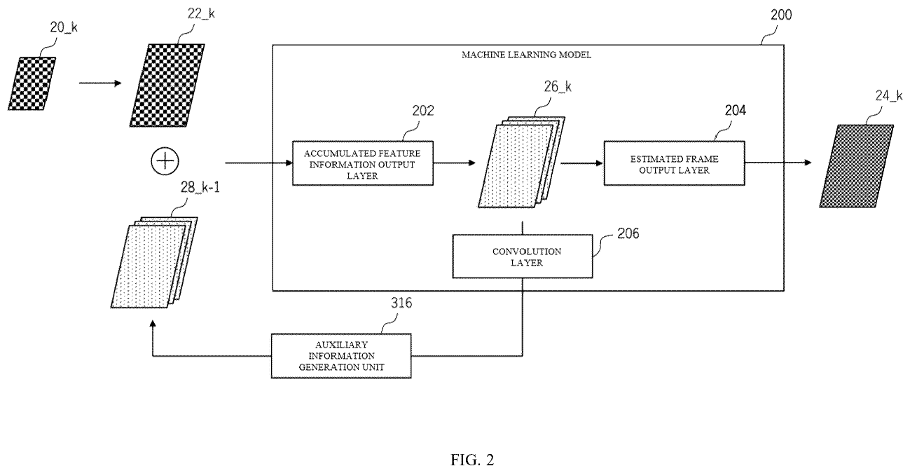

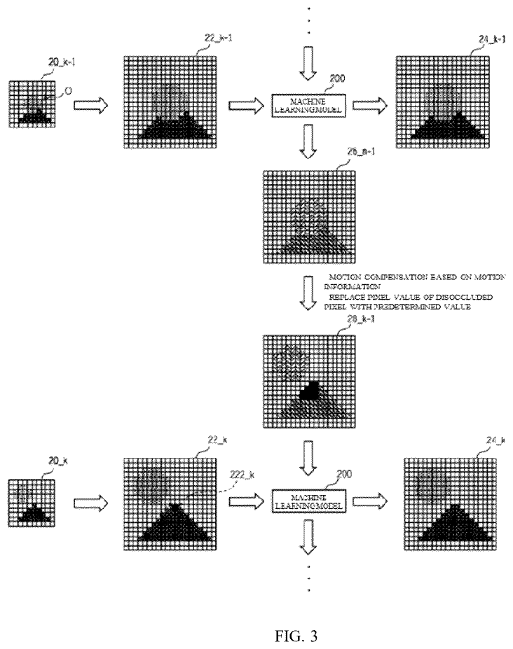

First, before describing an image processing system 1 according to the present embodiment, the Reference Technology that is the basis for the image processing system 1 according to the present embodiment will be described with reference to FIGS. 2 and 3. FIG. 2 is a diagram illustrating an overview of the Reference Technology. FIG. 3 is a diagram illustrating schematically processing in the Reference Technology. Here, an example will be given in which the Reference Technology is used to improve the image quality of gameplay moving images in a game. A gameplay moving image is a moving image generated in response to the game program executed by a control unit and user inputs received by an operation unit, and is composed of a plurality of still images (frames) that are time-series data. The Reference Technology mainly performs the following processing.

### (1) Generation of Processing Target Frames

First, a system according to the Reference Technology generates an image (a processing target frame) in which one or more game objects are drawn by rendering three-dimensional data that shows the game objects as seen from a predetermined viewpoint. This processing target frame is an image having a predetermined pixel count (initial pixel count) and a predetermined image quality (initial image quality) (see FIG. 3). The processing target frames are generated at predetermined time intervals. The pixel count of the processing target frame is, for example, 1920×1080 (1080p). Each generated processing target frame is not displayed directly on the display unit 18, but is temporarily stored in the storage unit 12 for subsequent processing. In the following description, processing for a kth processing target frame 20_k will be mainly illustrated; however, similar processing is also performed for other processing target frames (that is, k=2, 3, . . . , N).

### (2) Acquisition of Input Frames

Based on the acquired processing target frame 20_k, the system according to the Reference Technology acquires a frame (input frame) 22_k having a pixel count (input pixel count) greater than the initial pixel count. The input pixel count is, for example, 3840×2160 (4K). Specifically, enlargement and interpolation processes are performed on the processing target frame 20_k to generate the input frame 22_k (see FIG. 3).

Here, it should be noted that although an input frame 22_k has a greater number of pixels than a processing target frame 20_k, its image quality has not necessarily been sufficiently improved. In other words, the image quality of a frame does not simply refer to the pixel count (high resolution). The image quality of a frame may be evaluated based on, for example, a high signal-to-noise ratio, high spatial frequency reproducibility, and high temporal stability (fewer artifacts and flickering when multiple frames are displayed consecutively), when compared with a reference frame, either individually or based on a combination of these factors.

### (3) Acquisition of Estimated Frames

The system according to the Reference Technology inputs the input frame 22_k to a machine learning model 200 and acquires an estimated frame 24_k. The estimated frame 24_k is an image having the same pixel count (estimated pixel count) as the input pixel count and image quality (estimated image quality) that is equal to or greater than the initial image quality (see FIG. 3).

Here, in addition to the input frame 22_k, the machine learning model 200 is input with a k−1th piece of auxiliary information 28_k−1 (see FIGS. 2 and 3). The auxiliary information 28k−1 is information based on a k−1th piece of accumulated feature information 26_k−1 that indicates features of the first to k−1th input frames 22. The accumulated feature information 26 and the auxiliary information 28 will be described in detail later.

Further, a machine learning model 200 is a model trained using multiple pieces of training data, each of which includes a training input frame having an input pixel count, and a training estimated frame having an estimated pixel count and estimated image quality.

### (4) Acquisition of Accumulated Feature Information

The machine learning model 200 has an accumulated feature information output layer 202 that receives the input frame 22_k and the auxiliary information 28_k−1, and outputs a kth piece of accumulated feature information 26_k that indicates features of the first to kth input frames 22 (see FIG. 2). The system according to the Reference Technology acquires the kth piece of accumulated feature information 26_k.

The acquired kth piece of accumulated feature information 26_k is input into an estimated frame output layer 204, which outputs the kth estimated frame 24_k (see FIG. 2). The acquired kth piece of accumulated feature information 26_k is also stored in a storage unit 12 and used to estimate the estimated frame 24_k+1 corresponding to the next processing target frame (k+1th processing target frame) 20_k+1.

### (5) Acquisition of Auxiliary Information

As described above, the k−1th piece of accumulated feature information 26k−1 is information that indicates the features of the first to k−1th input frames 22 (and thus the first to k−1th processing target frames 20). If the accumulated feature information 26_k−1, which accumulates information on the past processing target frames 20, is used to estimate the kth estimated frame 24_k, the amount of information available for estimation increases, and thus a high-quality estimated frame 24_k can be acquired.

However, if a displayed game object is moved between the k−1th processing target frame 20_k−1 and the kth processing frame 20_k, when the kth input frame 22_k and the accumulated feature information 26_k−1 are input as is to the machine learning model 200, a phenomenon (the so-called ghosting) may occur in which an afterimage of the game object that was displayed in the k−1st processing frame 20_k−1 is displayed.

Therefore, the system according to the Reference Technology acquires the k−1th piece of auxiliary information 28_k−1 by applying various corrections described below to the accumulated feature information 26_k−1 based on information acquired during rendering (for example, motion vectors or depth buffer) (see “auxiliary information generation unit 316” in FIG. 2, and also FIG. 3). As described above, the acquired k−1th piece of auxiliary information 28_k−1 is input into the machine learning model 200 together with the kth input frame 22_k, and is used to estimate the kth estimated frame 24_k.

As described above, the system according to the Reference Technology estimates the estimated frame 24 using the input frame 22 corresponding to the current processing target frame 20 as well as the auxiliary information 28 in which past information is accumulated. This increases the amount of information available for estimation, making it possible to acquire the high-quality estimated frame 24.

### 3. Overview of Image Processing System

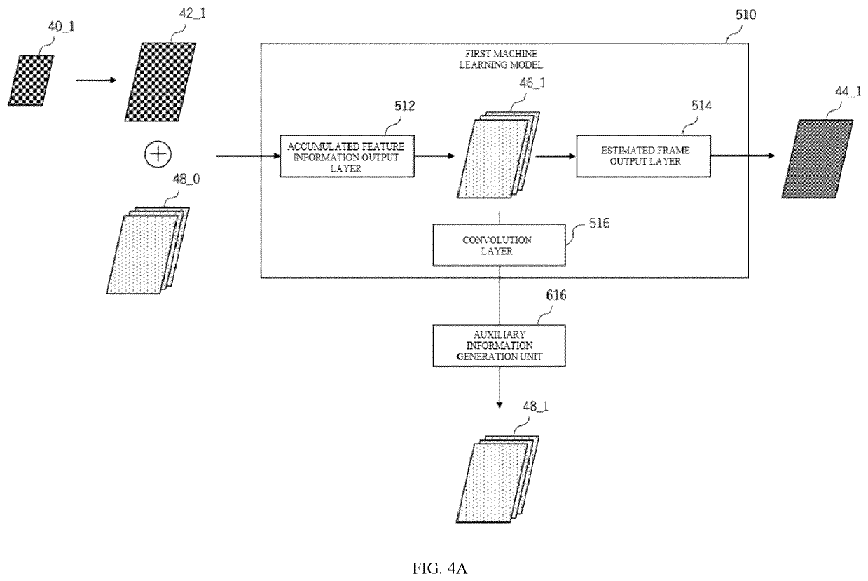

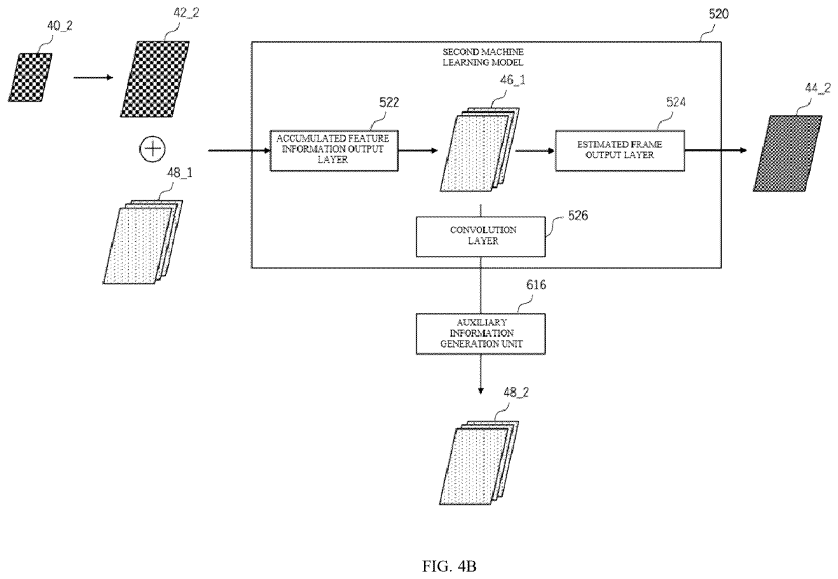

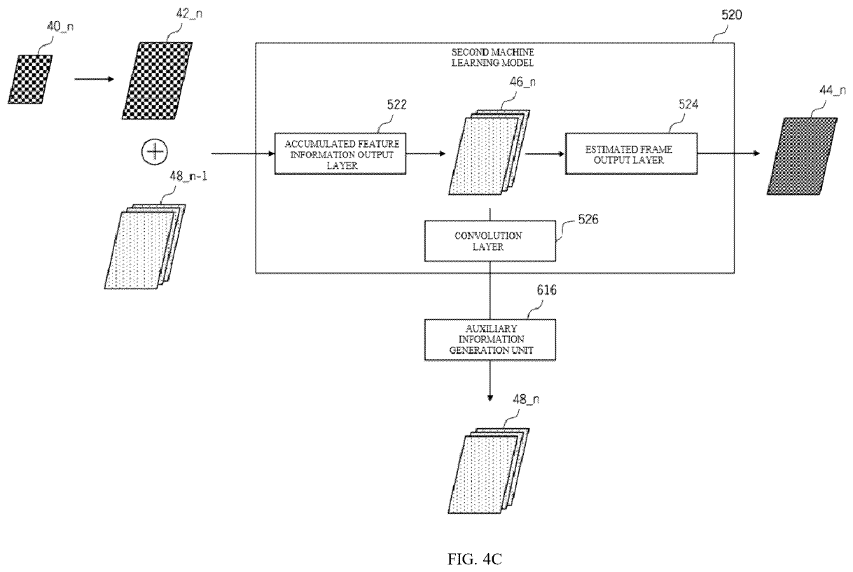

Hereinafter, details of an image processing system 1 will be described with reference to FIGS. 4A to 4C. FIGS. 4A to 4C are diagrams illustrating an overview of the image processing system 1. In the following, explanations of configurations similar to those of the Reference Technology may be omitted.

According to the Reference Technology, by using the accumulated feature information (auxiliary information) that accumulates information on past frames in addition to the current frame for estimation, it is possible to improve the estimation accuracy of the machine learning model.

However, if estimations for early frames and later frames are performed using a single machine learning model, as in the Reference Technology mentioned above, the accuracy of estimations for early frames will be lower than that for later frames, since less information about past frames has been accumulated in the early stages. In particular, for the first frame, the decrease in estimation accuracy is more pronounced since no information on past frames has been stored.

Therefore, in the image processing system 1 according to the present embodiment, a machine learning model (first machine learning model 510) that performs estimations on early frames and a machine learning model (second machine learning model 520) that performs estimations on frames later than the early frames are separately prepared. Hereinafter, the present embodiment will be specifically described below.

### (1) Processing of First Input Frames

First, the first machine learning model 510 outputs, based on a first input frame 42_1, a first estimated frame 44_1 and a first piece of accumulated feature information 46_1 indicating features of the first input frame 42_1 (see FIG. 4A). Here, given auxiliary information 48_0 (given feature information) is input into the first machine learning model 510 along with the first input frame 42_1. In the image processing system 1, similarly to the Reference Technology, a first piece of auxiliary information 48_1 is generated based on the first piece of accumulated feature information 46_1.

Further, the first machine learning model 510 is a model trained using a first piece of training data, which includes a first training input frame having an input pixel count, and a first training estimated frame having an estimated pixel count.

### (2) Processing of Second Input Frames

The second machine learning model 520 outputs, based on a second input frame 42_2 and the first piece of accumulated feature information (first piece of auxiliary information 48_1 in the present embodiment), a second estimated frame 44_2 and a second piece of accumulated feature information 46_2 indicating features of the first to second input frames (see FIG. 4B). Here, the first auxiliary information 48_1 input into the second machine learning model 520 is output from the first machine learning model 510 as described above.

As a result, the information indicating the features of the input frame 42 extracted by the first machine learning model 510 is passed on to the second machine learning model 520, so that the second machine learning model 520 can also use the information indicating the features of the input frame 42 prior to the second input frame 42_2 for estimation.

(3) Processing of n-th Input Frames

Thereafter, the second machine learning model 520 outputs the nth estimated frame 44_n and the nth piece of accumulated feature information 46_n indicating the features of the first to nth input frames, based on the nth input frame 42_n (n is a natural number greater than or equal to 3 and less than or equal to N) and the n−1th piece of accumulated feature information (n−1th piece of auxiliary information 48_n−1 in the present embodiment) indicating the features of the first to mth input frames (see FIG. 4C).

Further, the second machine learning model 520 is a model trained using the second to Nth pieces of training data, which includes the second to Nth training input frames having the input pixel count, and the second to Nth training estimated frames having the estimated pixel count. In the present embodiment, the training of the second machine learning model 520 and the training of the first machine learning model 510 are performed independently of each other. Further, the second machine learning model 520 is trained based on a first piece of training accumulated feature information that indicates features of the first training input frame and is output from the first machine learning model 510. That is, when the second machine learning model 520 is trained, the same processing as in (2) above is performed.

According to the above configuration, estimation for the early frames and estimation for the frames later than the early frames are performed using separate machine learning models, so that accurate estimation can be performed even for the early frames. Hereinafter, details of the image processing system 1 will be described.

### 4. Functions Implemented in Image Processing System

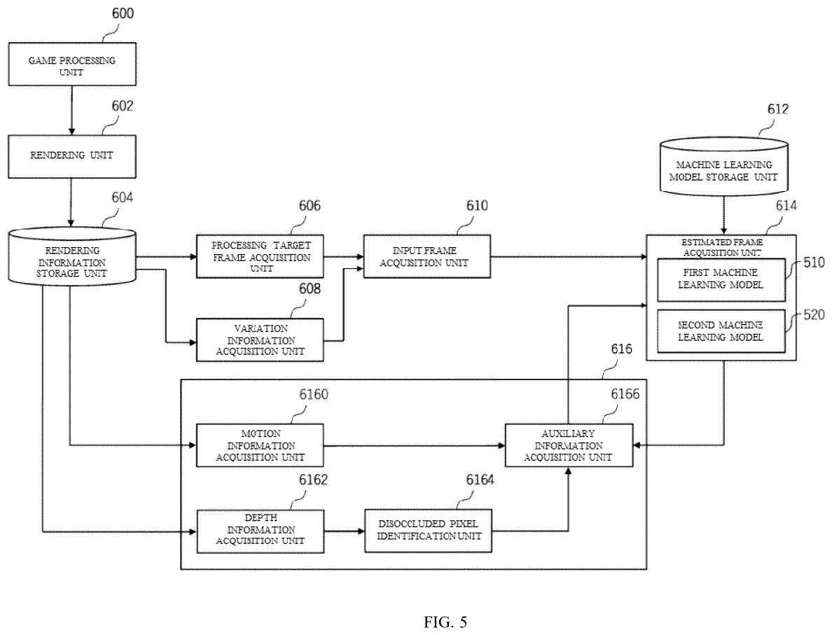

FIG. 5 is a functional block diagram illustrating one example of functions implemented in the image processing system 1. As shown in FIG. 5, the image processing system 1 includes a game processing unit 600, a rendering unit 602, a rendering information storage unit 604, a processing target frame acquisition unit 606, a variation information acquisition unit 608, an input frame acquisition unit 610, a machine learning model storage unit 612, an estimated frame acquisition unit 614, and an auxiliary information generation unit 616. The auxiliary information generation unit 616 includes a motion information acquisition unit 6160, a depth information acquisition unit 6162, a disoccluded pixel identification unit 6164, and an auxiliary information acquisition unit 6166. The game processing unit 600, the rendering unit 602, the processing target frame acquisition unit 606, the variation information acquisition unit 608, the input frame acquisition unit 610, the estimated frame acquisition unit 614, the motion information acquisition unit 6160, the depth information acquisition unit 6162, the disoccluded pixel identification unit 6164, and the auxiliary information acquisition unit 6166 are mainly implemented by the control unit 10.

The rendering information storage unit 604 and the machine learning model storage unit 612 are mainly implemented by the storage unit 12. The game processing unit 600, the rendering unit 602, and the rendering information storage unit 604 are functions provided by the game software.

### Game Processing Unit

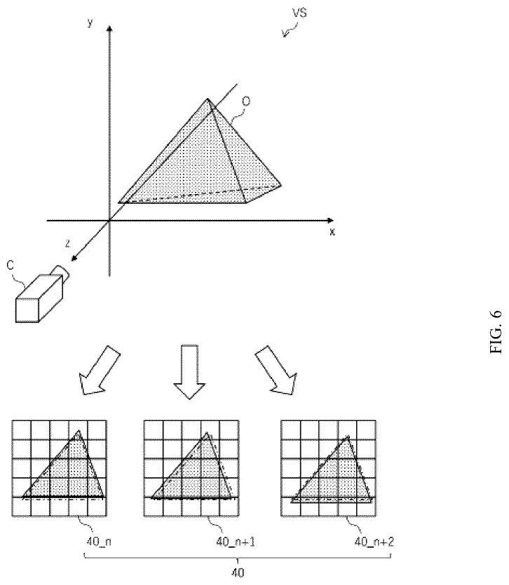

The game processing unit 600 executes various processing operations related to the game. The game processing unit 600 performs processing such as arranging a game object O in a three-dimensional virtual space VS, operating or moving the game object O, and changing a viewpoint C from which the three-dimensional virtual space VS is viewed, in accordance with, for example, a game program executed by the control unit 10 and user inputs received by the operation unit 16 (see FIG. 6). The game object O is composed of primitives such as polygons represented by three-dimensional data. The three-dimensional data includes geometric information indicating positions of vertices, topological information indicating how the vertices are connected, and attribute information such as color.

### Rendering Unit

FIG. 6 is a diagram illustrating processing in the rendering unit 602. The rendering unit 602 generates the first to Nth (N is a natural number greater than or equal to 2) processing target frames 40 by rendering (drawing) of three-dimensional data representing one or more game objects O viewed from the predetermined viewpoint C. The rendering unit 602 performs rendering based on the results of various processing executed by the game processing unit 600. Specifically, the rendering unit 602 performs vertex processing (vertex shading) and pixel processing (pixel shading) based on the three-dimensional data representing the game object O arranged in the three-dimensional virtual space VS. Vertex processing includes coordinate transformation processing (perspective projection) from the view coordinate system to the screen coordinate system, and a numerical value related to variation in the viewpoint C is added to a perspective projection matrix (camera matrix) used in the coordinate transformation processing, as described below. The rendering unit 602 may perform rendering based on, for example, light source information, depth information (depth buffer), texture information, and normal information. In addition to the above processing, the rendering unit 602 may also perform processing to apply effects such as depth-of-field (DoF) and motion blur. The processing of the rendering unit 602 may be set as appropriate by, for example, game software developers. Here, the game software developers may adjust MIP of the texture according to, for example, the estimated pixel count of the estimated frame 44. This makes it possible to suppress the occurrence of noise such as moire in the estimated frame 44.

Here, the rendering unit 602 generates each processing target frame 40 by rendering so that the viewpoint C varies for each processing target frame 40. Here, even if the game processing unit 600 fixes the viewpoint C at a predetermined position, the rendering unit 602 varies the viewpoint C for each processing target frame 40. As a result, as shown in FIG. 6, the position of the displayed game object O varies in each of the processing target frames 40_n, 40_n+1, and 40_n+2. In other words, the rendering unit 602 applies jitter when generating each processing target frame 40. Specifically, the rendering unit 602 varies the viewpoint C for each processing target frame 40 by adding a numerical value corresponding to a size less than one pixel, which differs for each processing target frame 40, to the perspective projection matrix. The rendering unit 602 varies the viewpoint C for each processing target frame 40 according to a predetermined sequence. As such a rule, for example, the Halton sequence can be used.

### Rendering Information Storage Unit

The rendering information storage unit 604 stores information necessary for the rendering processing in the rendering unit 602 and information acquired as a result of the rendering processing. For example, the rendering information storage unit 604 stores the processing target frame 40. Further, the rendering information storage unit 604 stores the variation information, the motion information, and the depth information. The variation information, the motion information, and the depth information will be described in detail later. Moreover, the rendering information storage unit 604 may store parameters used in coordinate transformation, light source information, texture information, normal information, and the like.

### Processing Target Frame Acquisition Unit

The processing target frame acquisition unit 606 acquires the first to Nth processing target frames 40, respectively. Specifically, the processing target frame acquisition unit 606 acquires the first to Nth processing target frames 40, respectively, which are stored in the rendering information storage unit 604.

### Variation Information Acquisition Unit

The variation information acquisition unit 608 acquires the variation information. The variation information acquisition unit 608 acquires the variation information, which is stored in the rendering information storage unit 604. Specifically, the variation information is information indicating the amount of variation of the viewpoint C between before and after the variation. The information indicating the amount of variation can also be referred to as a variation vector indicating a direction and a distance of the variation. For example, since the above-mentioned Halton sequence contains information indicating the amount of variation of the viewpoint C, this information may be used as the variation information.

### Input Frame Acquisition Unit

The input frame acquisition unit 610 acquires the first to Nth (N is a natural number greater than or equal to 3) input frames 42, each having a predetermined input pixel count, in response to the first to Nth processing target frames 40, each having a predetermined initial pixel count. In the present embodiment, each input frame 42 has an input pixel count that is greater than the initial pixel count. That is, in the present embodiment, each input frame 42 is an enlarged image of the processing target frame 40 corresponding to the input frame 42.

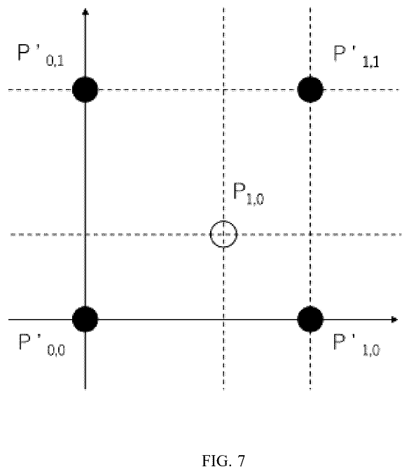

Specifically, the input frame acquisition unit 610 interpolates pixel values at positions in the processing target frame 40 corresponding to each pixel before the variation based on the variation information and each pixel of each processing target frame 40, and generates each input frame 42. FIG. 7 is a diagram illustrating processing in the input frame acquisition unit 610. FIG. 7 illustrates an example in which the nth input frame 42_n is acquired. For example, as shown in FIG. 7, if the pixel center of a pixel in the input frame 42_n to be acquired is P1,0, the input frame acquisition unit 610 determines the pixel value of P1,0 by bilinear interpolation based on the coordinates and pixel values of the pixel centers P′0,0, P′1,0, P′0,1, and P′1,1 of the four pixels closest to P1,0 in the processing target frame 40_n. Here, P′1,0 is located at a position shifted from P1,0 by the amount of variation indicated by the variation information. The pixel values of the pixels newly generated by the enlargement processing are calculated in the same manner. As the interpolation method, various known methods such as bicubic interpolation and Lanczos interpolation can be used in addition to bilinear interpolation.

When rendering is performed so that the viewpoint C varies for each processing target frame 40, the amount of time-series information increases. However, by using each processing target frame 40 acquired in this way (hereinafter referred to as a “variation processing target frame”) for estimation, the estimated frame 44 with higher image quality can be acquired.

On the other hand, if the variation processing target frame (or an enlarged image thereof) is input directly into the first machine learning model 510 or the second machine learning model 520, the influence of the variation in the viewpoint C described above may result in a decrease in the accuracy of estimation.

Specifically, the image processing system 1, as described above, is configured to interpolate pixel values at positions in the processing target frame 40 corresponding to each pixel before the variation based on the variation information and each pixel of each processing target frame 40, generate each input frame 42, and input this into the first machine learning model 510 or the second machine learning model 520. This corrects the influence of the variation in the viewpoint C, making it possible to prevent a decrease in the accuracy of estimation.

### First Machine Learning Model

The first machine learning model 510 is a model that estimates the first estimated frame 44 1 based on the first input frame 42_1. Specifically, the first machine learning model 510 outputs the first estimated frame 44 1 based on the first input frame 42_1 and the given auxiliary information 48_0. The given auxiliary information 48_0 is data in the same format as the auxiliary information 48_1 and 48_n−1, which will be described later. In particular, the first machine learning model 510 is a convolutional neural network (CNN). As the first machine learning model 510, known models such as a multi-layered ResNet with a residual connection mechanism or a so-called encoder-decoder U-Net can be used. As the first machine learning model 510, the model described in Non-Patent Document 1 may be used.

The first machine learning model 510 is a model trained using the first piece of training data, which includes the first training input frame having the input pixel count, and the first training estimated frame having the estimated pixel count. More specifically, the first machine learning model 510 is trained using first training data including the first training input frame, the given training auxiliary information, and the first training estimation frame having the estimated pixel count. Specifically, the first machine learning model 510 is trained based on a loss between the first training estimated frame and an output when the nth training input frame and the given training auxiliary information are input. The first machine learning model 510 is trained so as to reduce the loss. Various known techniques such as backpropagation can be used to train the first machine learning model 510.

Specifically, the first machine learning model 510 includes an accumulated feature information output layer 512, an estimated frame output layer 514, and a convolution layer 516 (see FIG. 4A).

The accumulated feature information output layer 512 receives the first input frame 42_1 and the given auxiliary information 48_0, and outputs the first piece of accumulated feature information 46_1 indicating the features of the first input frame 42_1. The accumulated feature information output layer 512 may be composed of, for example, one or more convolution layers. The accumulated feature information 46 is information having the same pixel count as the input pixel count (information in a bitmap format). The accumulated feature information 46_1 is also referred to as a feature map that indicates the features of the first input frame 42_1.

The estimated frame output layer 514 receives the first piece of accumulated feature information 46_1 and outputs the first estimated frame 44_1. Like the accumulated feature information output layer 512, the estimated frame output layer 514 may be composed of, for example, one or more convolutional layers. Alternatively, the estimated frame output layer 514 may be composed of one or more transposed convolutional layers (deconvolutional layers).

The convolution layer 516 is a layer that reduces the number of channels in the accumulated feature information 46 while maintaining the pixel count. The accumulated feature information 46 output from the convolution layer 516 is subjected to processing in the auxiliary information acquisition unit 6166. The convolution layer 516 reduces the dimension of the accumulated feature information 46, thereby reducing computational costs. The convolution layer 516 is, for example, a convolution layer with a kernel size of 1×1, but is not limited thereto.

### Second Machine Learning Model

The second machine learning model 520 is a model that estimates the second to Nth estimated frames 44 based on the second to Nth input frames 42. Specifically, the second machine learning model 520 outputs the second estimated frame 44_2, based on the second input frame 42_2 and the first piece of accumulated feature information (first piece of auxiliary information 48_1 in the present embodiment) output from the first machine learning model 510. Further, the second machine learning model 520 outputs the nth estimated frame 44_n, based on the nth input frame 42_n (n is a natural number greater than or equal to 3 and less than or equal to N) and the n−1th piece of accumulated feature information (n−1th piece of auxiliary information 48_n−1 in the present embodiment) indicating the features of the first to n−1th input frames 42. Similar to the first machine learning model 510, the second machine learning model 520 is a convolutional neural network (CNN). As the second machine learning model 520, known models such as a multi-layered ResNet with a residual connection mechanism or a so-called encoder-decoder U-Net can be used. As the second machine learning model 520, the model described in Non-Patent Document 1 may be used.

Specifically, the second machine learning model 520 includes an accumulated feature information output layer 522, an estimated frame output layer 524, and a convolution layer 526 (see FIGS. 4B and 4C). The convolutional layer 526 has the same configuration as the convolutional layer 516, and therefore its description will be omitted.

The accumulated feature information output layer 522 receives the second input frame 42_2 and the first piece of accumulated feature information (first piece of auxiliary information 48_1) output from the first machine learning model 510, and outputs the second piece of accumulated feature information 46_2 indicating the features of the first to second input frames 42. Further, the accumulated feature information output layer 522 receives the nth input frame 42_n and the n−1th piece of auxiliary information 48_n−1, and outputs the nth piece of accumulated feature information 46_n indicating the features of the first to nth input frames 42. The accumulated feature information output layer 522 may be composed of, for example, one or more convolution layers. The accumulated feature information 46 is information having the same pixel count as the input pixel count (information in a bitmap format). The nth piece of accumulated feature information 46_n is also referred to as a feature map that indicates the features of the first to nth input frames 42.

The estimated frame output layer 524 receives the second piece of accumulated feature information 46_2 and outputs the second estimated frame 44_2. Further, the estimated frame output layer 524 receives the nth piece of accumulated feature information 46_n and outputs the nth estimated frame 44_n. Like the accumulated feature information output layer 522, the estimated frame output layer 524 may be composed of, for example, one or more convolutional layers. Alternatively, the estimated frame output layer 524 may be composed of one or more transposed convolutional layers (deconvolutional layers).

The second machine learning model 520 is trained based on a first piece of training accumulated feature information that indicates features of the first training input frame and is output from the first machine learning model 510. Specifically, the first machine learning model 520 is trained based on a loss between the second training estimated frame and an output when the second training input frame and the first piece of training auxiliary information based on the first piece of training accumulated feature information output from the first machine learning model 510 are input. The second machine learning model 520 is trained so as to reduce the loss. Various known techniques such as backpropagation can be used to train the second machine learning model 520. Moreover, the second machine learning model 520 is a model trained using the second to Nth pieces of training data, which includes the second to Nth training input frames having the input pixel count, and the second to Nth training estimated frames having the estimated pixel count.

Specifically, the second machine learning model 520 is trained based on a loss between the second training estimated frame and an output when the nth training input frame and the n−1th piece of training auxiliary information based on the n−1th piece of training accumulated feature information, indicating the features of the first to n−1th training input frames, are input.

In the present embodiment, the case where the training of the first machine learning model 510 and the training of the second machine learning model 520 are performed independently of each other is described, but the first machine learning model 510 and the second machine learning model 520 may also be trained together.

### Machine Learning Model Storage Unit

The machine learning model storage unit 612 stores the first machine learning model 510 and the second machine learning model 520. Specifically, the machine learning model storage unit 612 stores parameters of the first machine learning model 510 and the second machine learning model 520 (such as the number of convolutional layers, the number of nodes used in each convolutional layer, and the weight of each node). Further, the first machine learning model 510 and the second machine learning model 520 have different parameters.

### Estimated Frame Acquisition Unit

The estimated frame acquisition unit 614 acquires the first estimated frame 44_1 based on the first input frame 42_1 and the first machine learning model 510. Specifically, the estimated frame acquisition unit 614 inputs the first input frame 42_1 and the given auxiliary information 48_0 into the first machine learning model 510 and acquires the first estimated frame 44_1.

Moreover, the estimated frame acquisition unit 614 acquires the second to Nth estimated frames 44, respectively, based on the second to Nth input frames 42 and the second machine learning model 520. Specifically, the estimated frame acquisition unit 614 inputs the second input frame 42_2 and the first piece of auxiliary information 48_1 into the second machine learning model 520 and acquires the second estimated frame 44_2. Further, the estimated frame acquisition unit 614 inputs the nth input frame 42_n and the n−1th piece of auxiliary information 48_n−1 into the second machine learning model 520 and acquires the nth estimated frame 44_n. Moreover, in the present embodiment, the estimated frame 44 has an estimated pixel count that is the same as the input pixel count.

### Auxiliary Information Generation Unit

The auxiliary information generation unit 616 generates the n−1th piece of auxiliary information 48_n−1 based on the n−1th piece of accumulated feature information 46_n−1. Furthermore, the auxiliary information generation unit 616 generates the first piece of auxiliary information 48_1 based on the first piece of accumulated feature information 46_1. The auxiliary information generation unit 616 includes a motion information acquisition unit 6160, a depth information acquisition unit 6162, a disoccluded pixel identification unit 6164, and an auxiliary information acquisition unit 6166.

### Motion Information Acquisition Unit

The motion information acquisition unit 6160 acquires the n−1th piece of motion information, which is the information indicating the amount and direction of motion from the n-1th processing target frame 40_n−1 to the nth processing target frame 40_n. Specifically, the n−1th piece of motion information is image information (bitmap format information) that has the same pixel count as the input pixel count and indicates the amount and direction of motion of each pixel between the n−1th processing target frame 40_n−1 and the nth processing target frame 40_n. In other words, a pixel value of each pixel in the n−1th piece of motion information indicates the amount and direction of motion of each pixel between the n−1th processing target frame 40_n−1 and the nth processing target frame 40_n. That is, the pixel value of each pixel in the n−1th piece of motion information is a two-dimensional vector that indicates the amount and direction of motion of each pixel between the n−1th processing target frame 40_n−1 and the nth processing target frame 40_n. The motion information is also called a motion vector. Specifically, the motion information acquisition unit 6160 acquires original motion information having the same pixel count as the initial pixel count, and performs enlargement and interpolation processing on the original motion information to acquire the motion information having the same pixel count as the input pixel count.

Further, the motion information acquisition unit 6160 acquires the first piece of motion information, which is the information indicating the amount and direction of motion from the first processing target frame 40_1 to the second processing target frame 40_2.

### Depth Information Acquisition Unit

The depth information acquisition unit 6162 acquires the n−1th piece of depth information indicating the depth of each pixel in the n−1th processing target frame 40_n−1, and the nth piece of depth information indicating the depth of each pixel in the nth processing target frame 40_n. Specifically, the depth information is information having the same pixel count as the input pixel count (information in a bitmap format). The depth information is also called a depth buffer or a Z buffer. Specifically, the depth information acquisition unit 6162 acquires original depth information having the same pixel count as the initial pixel count, and performs enlargement and interpolation processing on the original depth information to acquire the depth information having the same pixel count as the input pixel count.

The depth information acquisition unit 6162 acquires the first piece of depth information indicating the depth of each pixel in the first processing target frame 40_1.

### Disoccluded Pixel Identification Unit

The disoccluded pixel identification unit 6164 identifies, based on the n−1th piece of depth information and the nth piece of depth information, an nth disoccluded pixel 422_n, which is a pixel among the pixels of the nth input frame 42_n at which all or part of the game object O that is not displayed in the nth input frame 42_n−1 (see FIG. 5). Specifically, the disoccluded pixel identification unit 6164 identifies the nth disoccluded pixel 422_n based on a difference between the n−1th piece of depth information and the nth piece of depth information. Further, the disoccluded pixel identification unit 6164 may identify the nth disoccluded pixel 422_n based on the n−1th perspective projection matrix associated with the n−1th input frame 42_n−1 and the nth perspective projection matrix associated with the nth input frame 42_n. Specifically, the disoccluded pixel identification unit 6164 may identify the nth disoccluded pixel 422_n using the n−1th piece of motion information. More specifically, the disoccluded pixel identification unit 6164 identifies the nth disoccluded pixel 422_n and generates an nth piece of disoccluded pixel information, which is image information indicating a position of the nth disoccluded pixel 422_n.

Further, the disoccluded pixel identification unit 6164 identifies, based on the first piece of depth information and the second piece of depth information, the second disoccluded pixel 422_2, which is a pixel among the pixels of the second input frame 42_2 at which all or part of the game object O that is not displayed in the first input frame 42_1.

### Auxiliary Information Acquisition Unit

The auxiliary information acquisition unit 6166 acquires the n−1th piece of auxiliary information 48_n−1 by applying motion compensation to the n−1th piece of accumulated feature information 46_n−1 based on the n−1th piece of motion information. Motion compensation refers to a process of moving a pixel at a position x in the n−1th piece of accumulated feature information 46_n to a position x′, for example, when a pixel at the position x in the n−1th input frame 42_n−1 has moved to the position x′ in the nth input frame 42_n (see FIG. 3). That is, the auxiliary information acquisition unit 6166 acquires the n−1th piece of auxiliary information 48_n−1 based on the n−1th piece of motion information to which a pseudo-random number related to the n−1th piece of accumulated feature information 26_n−1 has been added, by setting pixel values of one or more pixels in the n−1th piece of accumulated feature information 46_n−1 to pixels at positions moved in accordance with the amount and direction of motion of the pixels.

Further, the auxiliary information acquisition unit 6166 acquires the first piece of auxiliary information 48_1 by applying motion compensation to the first piece of accumulated feature information 46_1 based on the first piece of motion information.

In the case where the game object O is moved between the nth processing target frame 40_n and the n−1th processing target frame 40_n−1, when acquiring the nth estimated frame 44_n, if the nth input frame 42_n and the n−1th piece of accumulated feature information 46_n−1 are input directly into the machine learning model 500, ghosting may occur in which an afterimage of the game object O that was displayed in the nth input frame 42_n is displayed in the output nth estimated frame 44_n.

Therefore, the image processing system 1, as described above, applies motion compensation to the n−1th piece of accumulated feature information 46_n−1 based on the n−1th piece of motion information to acquire the n−1th piece of auxiliary information 48_n−1, and when acquiring the nth estimated frame 44_n, this n−1th piece of auxiliary information 48_n−1 is input into the machine learning model 500. This makes it possible to suppress the ghosting.

Furthermore, the auxiliary information acquisition unit 6166 acquires the n−1th piece of auxiliary information 48_n−1 by replacing the pixel value of the nth disoccluded pixel 422_n in the n−1th piece of accumulated feature information 46_n−1 with a predetermined value. Specifically, the auxiliary information acquisition unit 6166 acquires the n−1th piece of auxiliary information 48_n−1 based on the nth piece of disoccluded pixel information by replacing the pixel value of the nth disoccluded pixel 422_n in the n−1th piece of accumulated feature information 46_n−1 with a predetermined value. The predetermined value may be a constant value such as 0 (black), or may be the pixel value of the nth disoccluded pixel 422_n in the nth input frame 42_n.

The auxiliary information acquisition unit 6166 acquires the first piece of auxiliary information 48_1 by replacing the pixel value of the second disoccluded pixel 422_2 in the first piece of accumulated feature information 46_1 with a predetermined value.

In the case all or part of the game object O that is not displayed in the n−1th processing target frame 40_n−1 is displayed in the nth processing target frame 40_n when acquiring the nth estimated frame 44_n, if the nth input frame 42_n and the n−1th piece of accumulated feature information 46_n−1 are input directly into the machine learning model 500, the ghosting mentioned above may occur in the output nth estimated frame 44_n.

Accordingly, the image processing system 1 is designed to, as described above, acquire the n−1th piece of auxiliary information 48_n−1, by identifying the nth disoccluded pixel 422_n, which is a pixel among the pixels of the nth input frame 42_n at which all or part of the game object O that is not displayed in the n−1th input frame 42_n−1 is displayed, and replacing a pixel value of the nth disoccluded pixel 422-n in the n−1th piece of accumulated feature information 46_n−1 with a predetermined value. This makes it possible to suppress the ghosting.

### 4. Processing Executed in Image Processing System

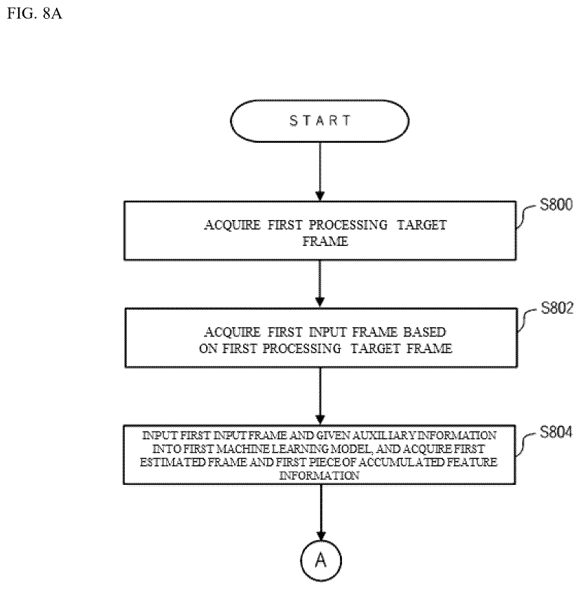

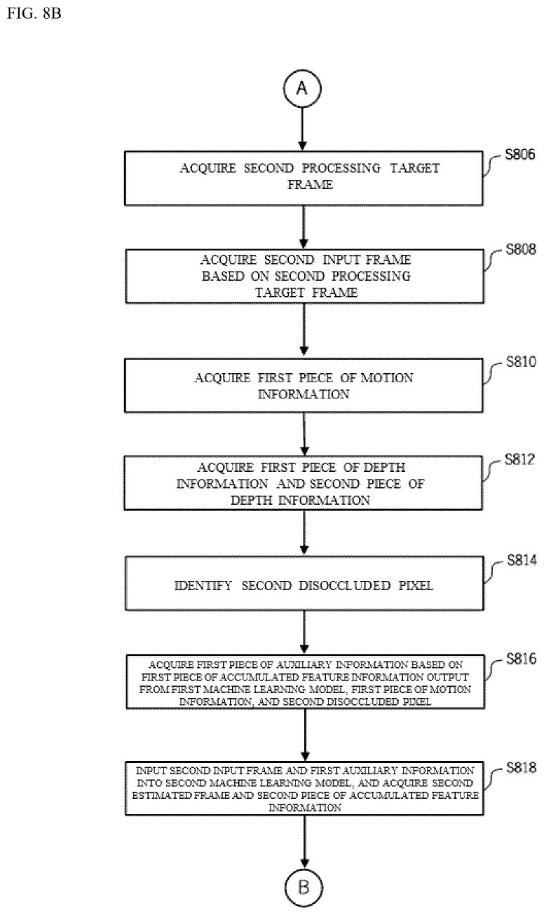

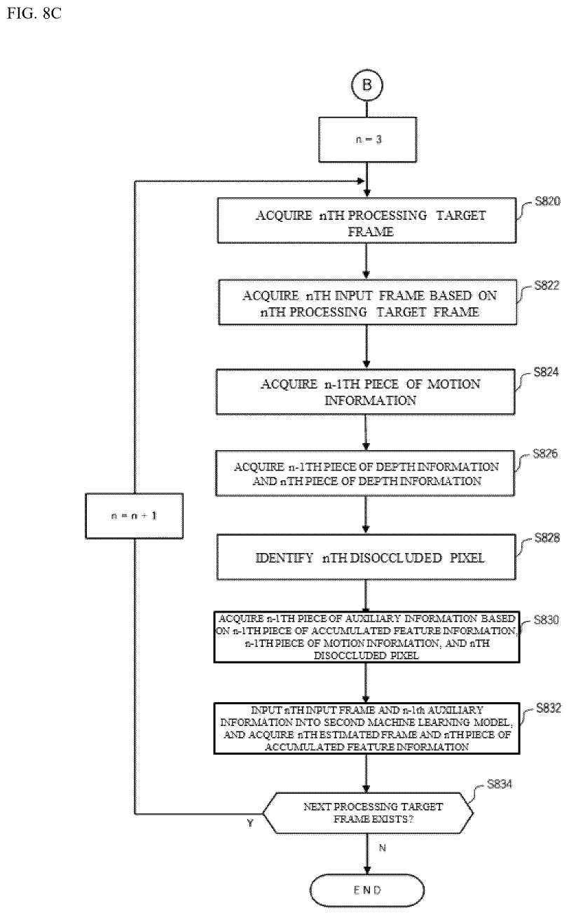

FIGS. 8A to 8C are flow diagrams illustrating one example of the processing flow executed in the image processing system 1. The processing shown in FIGS. 8A to 8C is executed by the control unit 10 operating in accordance with the programs stored in the storage unit 12.

First, as shown in FIG. 8A, the control unit 10 acquires the first processing target frame 40_1 (S800). The control unit 10 acquires the first input frame 42_1 based on the first processing target frame 40_1 (S802). Specifically, the control unit 10 inputs the first input frame 42_1 and the given auxiliary information 48_0 into the first machine learning model 510 and acquires the first estimated frame 44_1 and the first piece of accumulated feature information 46_1 (S804).

Moving to FIG. 8B, the control unit 10 acquires the second processing target frame 40_2 (S806). The control unit 10 acquires the second input frame 42_2 based on the second processing target frame 40_2 (S808).

Moreover, the control unit 10 acquires the first piece of motion information (S810). Further, the control unit 10 acquires the first piece of depth information and the second piece of depth information (S812), and identifies the second disoccluded pixel 422_2 based on the first piece of depth information and the second piece of depth information (S814). The control unit 10 acquires the first piece of auxiliary information 48_1 based on the first piece of accumulated feature information 46_1, the first piece of motion information, and the second disoccluded pixel 422_2 (S816). Moreover, the control unit 10 inputs the second input frame 42_2 and the first piece of auxiliary information 48_1 into the second machine learning model 520 and acquires the second estimated frame 44_2 and the second piece of accumulated feature information 46 2 (S818).

Next, the control unit 10 acquires the nth processing target frame 40_n (S820). The control unit 10 acquires the nth input frame 42_n based on the nth processing target frame 40_n (S822).

Moreover, the control unit 10 acquires the n−1th piece of motion information (S824). Further, the control unit 10 acquires the n−1th piece of depth information and the nth piece of depth information (S826), and identifies the nth disoccluded pixel 422_n based on the n−1th piece of depth information and the nth piece of depth information (S828). The control unit 10 acquires the n−1th piece of auxiliary information 48_n−1 based on the n−1th piece of accumulated feature information 46_n−1, the n−1th piece of motion information, and the nth disoccluded pixel 422_n (S830). Moreover, the control unit 10 inputs the nth input frame 42_n and the n−1th piece of auxiliary information 48_n−1 into the second machine learning model 520 and acquires the nth estimated frame 44_n and the nth piece of accumulated feature information 46_n (S832). The control unit 10 determines whether or not the next frame exists (S834), and if it determines that the next frame exists (S834: Y), it increments n =n+1 and repeats the processing of S820 to S832. If the control unit 10 determines that the next frame does not exist (S834: N), it ends this processing. Moreover, if the control unit 10 determines that the next frame does not exist (S834: N), the control unit 10 may cause the display unit 18 to display the first to Nth estimated frames 44 as they are.

### 5. Summary

According to the image processing system 1 of the present embodiment described above, the kth estimated frame 44_k is estimated using the k−1th piece of accumulated feature information 46_k−1 that indicates the features of the first to k−1th input frames 42 (k=2, 3, . . . , N). That is, in addition to the information about the kth processing target frame 40_k, the information about the first to k−1th processing target frames 40 is available for estimation, so that the amount of information available for estimation increases, and a high-quality estimated frame 44_k can be acquired.

Further, according to the image processing system 1 of the present embodiment, estimation for the early frames and estimation for the frames later than the early frames are performed using separate machine learning models, so that accurate estimation can be performed even for the early frames.

The present disclosure is not limited to the above-described embodiment. Furthermore, the specific character strings and numerical values described above and the specific character strings and numerical values in the drawings are examples, and the present disclosure is not limited to these character strings and numerical values.

For example, in the present embodiment, a case has been exemplified in which the input pixel count is greater than the initial pixel count and the input pixel count is the same as the estimated pixel count; however, the input pixel count may be the same as the initial pixel count and the estimated pixel count may be greater than the input pixel count. That is, the input frame 42 does not necessarily have to be an enlarged image of the processing target frame 40.

Furthermore, the processing target frame 40 may be input directly into the machine learning model 500.

Further, in the present embodiment, the accumulated feature information 46 is processed into the auxiliary information 48 and then input into the first machine learning model 510 or the second machine learning model 520, but the accumulated feature information 46 may be input directly into the first machine learning model 510 or the second machine learning model 520.

Moreover, in the present embodiment, the case has been described in which only the first input frame 42_1 is input into the first machine learning model 510, and the second to Nth input frames 42 are input into the second machine learning model 520, but the present disclosure is not limited thereto. For example, the first to third input frames 42 may be input into the first machine learning model 510, and the fourth to Nth input frames 42 may be input into the second machine learning model 520. In short, the first machine learning model 510 is required to estimate the first to ith estimated frames 44 based on the first to ith input frames 42 (i is a natural number between 1 and N−2). Furthermore, the second machine learning model 520 is required to estimate the i+1th to jth estimated frames 44 based on the i+1th to jth input frames 42 (j is a natural number between i+2 and N).

Moreover, in the present embodiment, the image processing system 1 is described as including the first machine learning model 510 and the second machine learning model 520, but the image processing system 1 may also include more machine learning models. For example, the image processing system 1 may further include a third machine learning model.

Furthermore, in the present embodiment, the image processing system 1 is applied to game moving images, but the image processing system 1 is not limited to game moving images and may be applied to general moving images.

What is claimed is:

1. An system comprising:
one or more processors, and
one or more non-transitory computer readable media that store instructions which, when executed by the one or more processors, cause the one or more processors to perform operations comprising:
obtaining each of first to Nth input frames having an input pixel count equal to or greater than a predetermined initial pixel count, corresponding to first to Nth processing target frames having the predetermined initial pixel count, N being a natural number greater than or equal to 3;
obtaining each of first to ith estimated frames having an estimated pixel count greater than the initial pixel count, based on the first to ith input frames and a first machine learning model, i being a natural number greater than or equal to 1 and less than or equal to N−2; and
obtaining each of i+1th to estimated frames, based on the i+1th to jth input frames and a second machine learning model, j being a natural number greater than or equal to i+2 and less than or equal to N.

2. The system of claim 1, wherein the first machine learning model receives the first input frame and given feature information, and outputs the first estimated frame and the first piece of accumulated feature information.

3-4. (canceled)

5. The system of claim 1, wherein the first machine learning model outputs an nth estimated frame and an nth piece of accumulated feature information indicating features of the first to nth input frames based on the nth input frame, n being a natural number greater than or equal to 1 and less than or equal to i.

6. The system of claim 5, wherein the second machine learning model outputs the i+1th estimated frame and the i+1th piece of accumulated feature information indicating features of the first to i+1th input frames based on the i+1th input frame and the ith piece of accumulated feature information output from the first machine learning model and indicating features of the first to ith input frames.

7. The system of claim 6, wherein the second machine learning model outputs the mth estimated frame and the mth piece of accumulated feature information indicating features of the first to mth input frames based on the mth input frame and the m−1th piece of accumulated feature information indicating features of the first to m−1th input frames, m being a natural number equal to or greater than i+2 and less than or equal to j.

8. The system of claim 7, wherein the first machine learning model is further trained using first to ith pieces of training data, each of which includes first to ith training input frames having the input pixel count and first to ith training estimated frames having the estimated pixel count.

9. The system of claim 8, wherein the second machine learning model is further trained using the i+1th to jth pieces of training data which respectively includes the i+1th to jth training input frames having the input pixel count and the i+1th to jth training estimated frames having the estimated pixel count, and trained based on an ith piece of training accumulated feature information output from the first machine learning model and indicating features of the first to ith training input frames.

10. One or more non-transitory computer readable media that store instructions which, when executed by one or more processors, cause the one or more processors to perform operations comprising:
obtaining each of first to Nth input frames having an input pixel count equal to or greater than a predetermined initial pixel count, corresponding to first to Nth processing target frames having the predetermined initial pixel count, N being a natural number greater than or equal to 3;
obtaining each of first to ith estimated frames having an estimated pixel count greater than the initial pixel count, based on the first to ith input frames and a first machine learning model, i being a natural number greater than or equal to 1 and less than or equal to N−2; and
obtaining each of i+1th to jth estimated frames, based on the i+1th to jth input frames and a second machine learning model, j being a natural number greater than or equal to i+2 and less than or equal to N.

11. The media of claim 10, wherein the first machine learning model receives the first input frame and given feature information, and outputs the first estimated frame and the first piece of accumulated feature information.

12. The media of claim 10, wherein the first machine learning model outputs an nth estimated frame and an nth piece of accumulated feature information indicating features of the first to nth input frames based on the nth input frame, n being a natural number greater than or equal to 1 and less than or equal to i.

13. The media of claim 12, wherein the second machine learning model outputs the i+1th estimated frame and the i+1th piece of accumulated feature information indicating features of the first to i+1th input frames based on the i+1th input frame and the ith piece of accumulated feature information output from the first machine learning model and indicating features of the first to ith input frames.

14. The media of claim 13, wherein the second machine learning model outputs the mth estimated frame and the mth piece of accumulated feature information indicating features of the first to mth input frames based on the mth input frame and the m−1th piece of accumulated feature information indicating features of the first to m−1th input frames, m being a natural number equal to or greater than i+2 and less than or equal to j.

15. The media of claim 14, wherein the first machine learning model is further trained using first to ith pieces of training data, each of which includes first to ith training input frames having the input pixel count and first to ith training estimated frames having the estimated pixel count.

16. The media of claim 15, wherein the second machine learning model is further trained using the i+1th to jth pieces of training data which respectively includes the i+1th to jth training input frames having the input pixel count and the i+1th to jth training estimated frames having the estimated pixel count, and trained based on an ith piece of training accumulated feature information output from the first machine learning model and indicating features of the first to ith training input frames.

17. A computer-implemented method comprising:
obtaining each of first to Nth input frames having an input pixel count equal to or greater than a predetermined initial pixel count, corresponding to first to Nth processing target frames having the predetermined initial pixel count, N being a natural number greater than or equal to 3;
obtaining each of first to ith estimated frames having an estimated pixel count greater than the initial pixel count, based on the first to ith input frames and a first machine learning model, i being a natural number greater than or equal to 1 and less than or equal to N−2; and
obtaining each of i+1th to jth estimated frames, based on the i+1th to jth input frames and a second machine learning model, j being a natural number greater than or equal to i+2 and less than or equal to N.

18. The method of claim 17, wherein the first machine learning model receives the first input frame and given feature information, and outputs the first estimated frame and the first piece of accumulated feature information.

19. The method of claim 17, wherein the first machine learning model outputs an nth estimated frame and an nth piece of accumulated feature information indicating features of the first to nth input frames based on the nth input frame, n being a natural number greater than or equal to 1 and less than or equal to i.

20. The method of claim 19, wherein the second machine learning model outputs the i+1th estimated frame and the i+1th piece of accumulated feature information indicating features of the first to i+1th input frames based on the i+1th input frame and the ith piece of accumulated feature information output from the first machine learning model and indicating features of the first to ith input frames.

21. The method of claim 20, wherein the second machine learning model outputs the mth estimated frame and the mth piece of accumulated feature information indicating features of the first to mth input frames based on the mth input frame and the m−1th piece of accumulated feature information indicating features of the first to m−1th input frames, m being a natural number equal to or greater than i+2 and less than or equal to j.

22. The method of claim 21, wherein the first machine learning model is further trained using first to ith pieces of training data, each of which includes first to ith training input frames having the input pixel count and first to ith training estimated frames having the estimated pixel count.
